(19) United States
(12) Patent Application Publication
(10) Pub. No.: US 2024/0141093 A1
(43) Pub. Date: May 2, 2024

(54) Polyol and a Process for the Preparation Thereof

(71) Applicant: BASF SE, Ludwigshafen am Rhein (DE)

(72) Inventors: Yue YANG, Wyandotte, MI (US); Theodore M. Smiecinski, Wyandotte, MI (US); Thomas H. Plegue, Wyandotte, MI (US); Mark Patrick McBride, Wyandotte, MI (US)

(73) Assignee: BASF SE, Ludwigshafen am Rhein (DE)

(21) Appl. No.: 18/550,846

(22) PCT Filed: Mar. 17, 2022
(86) PCT No.: PCT/EP2022/056914

§ 371 Date: Sep. 15, 2023

Related U.S. Application Data
(60) Provisional application No. 63/163,191, filed on Mar. 19, 2021.

(30) Foreign Application Priority Data
Apr. 23, 2021 (EP) 21170318.6

(51) Int. Cl. C08G 18/32; C08G 18/20; C08G 18/24; C08G 18/30; C08G 18/76; C08G 65/26; C08J 9/14

(52) U.S. Cl. CPC C08G 18/3206; C08G 18/2027; C08G 18/244; C08G 18/302; C08G 18/3275; C08G 18/7621; C08G 18/7671; C08G 65/2609; C08J 9/142; C08G 2110/0008; C08J 2203/12; C08J 2205/06; C08J 2375/04

(57) ABSTRACT

A polyalkyleneoxy polyol (P) has an average nominal functionality in the range of 2 to 8; a hydroxy number in the range of 10 to 500 mg KOH/g measured according to ASTM method D4272; and a weight average molecular weight in the range of 500 to 25,000 measured using GPC with polystyrene standard and tetrahydrofuran as solvent. The polyol (P) contains ethyleneoxy in an amount in the range of 50 to 95 wt. %, based on the overall weight of the polyol (P).

### FIELD OF THE INVENTION

The presently claimed invention is directed to a polyalkyleneoxy polyol (P) having an average nominal functionality in the range of 2 to 8; a hydroxy number in the range of 10 to 500 mg KOH/g measured according to ASTM method D4272; an average molecular weight in the range of 500 to 25000 measured using GPC with polystyrene standard and tetrahydrofuran as solvent; wherein the polyol comprises ethyleneoxy in an amount in the range of 50 to 95 wt. % based on overall weight of the polyol (P).

### BACKGROUND

Flexible polyurethane (PU) foams are foams which counteract pressure with low resistance. The properties of flexible polyurethane foams depend on the structure of the polyether polyols, isocyanates and additives. Flexible polyurethane foams are widely used in a diverse range of applications. A few primary sectors are the automotive and bedding industry, which include upholstered furniture as well as technical articles. For instance, full foam seats, dashboards, and restraints for back and head are all made from flexible polyurethane foam. Other applications of flexible polyurethane foam include carpet backings, bedding and mattresses, gaskets between a car body and its lights, lip seals of air filters for engines and insulating layers on car parts and engine parts to reduce sound and vibration.

The polyols used for producing flexible polyurethanes are primarily polyether polyols. Polyether polyols are typically obtained by reacting a starter compound or initiator having a plurality of active hydrogen atoms with one or more alkylene oxides. Normally, the polyether polyols used in the manufacture of flexible polyurethane foams are obtained by addition of either (i) propylene oxide exclusively or (ii) a mixture of propylene oxide and ethylene oxide having a high propylene oxide content to a starter compound with an appropriate hydroxyl functionality.

WO 2000.04071 discloses a polyoxyalkylene dispersion polyol for the preparation of hyper-soft polyurethane. The polyoxyalkylene dispersion polyols comprise a stable liquid-liquid dispersion of two distinct polyoxyalkylene polyols. A first polyol having a substantial, high polyoxypropylene content internal block and a high polyoxyethylene content external block; and a second polyol consisting largely of a high oxyethylene-content block, form a fine, liquid-liquid dispersion which resists separation and layering and is highly suitable for preparing polyurethane foams, particularly hyper-soft polyurethane foams.

The problem associated with hyper-soft polyurethanes prepared from such polyols and other commercial offerings is poor green strength and slower cure time. One of the factors that decides the better green strength and faster/moderate cure time is primary hydroxy content in the polyol. Thus, it is important to have a balance between primary hydroxy content and secondary hydroxy content. For the polyol having primary hydroxy content above 70%, undesirable side reactions maybe a concern with isocyanates, which in turn leads to polyurethane with undesired property. The less amount of content will lead to a slower reaction-leading to higher material loss and processing time. The existing hyper-soft formulations produce foam blocks being more dough-like, easily deformed, which tends to press into, hang-up, not progress onto a moving belt/roller conveyor system resulting in a reduction of production efficiencies and yields. Furthermore, the deforming characteristic of the slow curing main block is more difficult to cut into smaller blocks. These smaller blocks must continue to roll along the same conveyor system without deforming into the belt/roller gap spacings. The entire block handling system with curing foam must work in concert from the beginning of the pour, cutting, lifting, conveyor type transfers, and finish in a storage curing rack system with many moving parts over several thousand square feet of tunnel and warehouse space. Thus, it is desirable to provide new polyols together with known isocyanates to create PUs with improved green strength and faster cure time without impacting the physical properties of the hyper-soft polyurethane. These faster cure times allow for easier foam bun handling during the production environments leading to less product loss and personnel interference. Also, a faster cure time may allow for a faster production speed for hyper-soft formulations. In addition, for molded applications improving de-mold time is very important and this correlates to a faster curing speed.

Thus, it is an object of the presently claimed invention to provide a polyol, which can be reacted with known isocyanates to create PUs with improved green strength and faster cure time without impacting the physical properties of the polyurethane. It is also an object of the presently claimed invention to provide a polyol that can be used to formulate PU foams with improved load bearing capacity (IFDs) in molded applications.

### SUMMARY OF THE INVENTION

Surprisingly, it has been found that a polyol according to the presently claimed invention leads to hyper-soft polyurethane formulations having higher green strength, and faster cure time without impacting the physical properties of the polyurethane. The polyurethane foam formed with polyol according to presently claimed invention also displayed improved load bearing capacity (IFDs) in molded applications.

Thus, in a first aspect, the presently claimed invention is directed to a polyalkyleneoxy polyol (P) having an average nominal functionality in the range of 2 to 8;
a hydroxy number in the range of 10 to 500 mg KOH/g measured according to ASTM method D4272;
a weight average molecular weight in the range of 500 to 25000 measured using GPC with polystyrene standard and tetrahydrofuran as solvent;
wherein the polyol (P) comprises ethyleneoxy in an amount in the range of 50 to 95 wt. % based on overall weight of the polyol (P); and
a primary hydroxy content is in the range of 30 to 65% based on total hydroxy content of polyol (P).

In a second aspect, the presently claimed invention is directed to a process for preparing a polyalkyleneoxy polyol (P) according to first aspect comprising the steps of:
i. providing at least one polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product.

In a third aspect, the presently claimed invention is directed to a polyurethane copolymer obtained by reacting a reaction mixture comprising:
v. at least one isocyanate (A); and
vi. at least one polyol (P) according to the first aspect of the presently claimed invention.

In a fourth aspect, the presently claimed invention is directed to a process for preparing a polyurethane copolymer comprising at least the steps of:
vii. providing at least one isocyanate (A);
viii. providing at least one polyol (P) according to the first aspect of the present invention; and
ix. reacting (A) and (P).

In a fifth aspect, the presently claimed invention is directed to an article comprising a polyurethane copolymer comprising a polyol according to presently claimed invention.

In sixth aspect of the presently claimed invention is directed to a polyol (P) obtained a process comprising the steps of:
i. providing at least one polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product,

wherein the polyol (P) having an average nominal functionality in the range of 2 to 8;
a hydroxy number in the range of 10 to 500 mg KOH/g measured according to ASTM method D4272;
a weight average molecular weight in the range of 500 to 25000 measured using GPC with polystyrene standard and tetrahydrofuran as solvent;
wherein the polyol (P) comprises ethyleneoxy in an amount in the range of 50 to 95 wt. % based on overall weight of the polyol (P); and
a primary hydroxy content is in the range of 30 to 65% based on total hydroxy content of polyol (P).

### DESCRIPTION OF THE DRAWING

FIG. 1 discloses the gelling time of a polyurethane prepared with inventive polyol according to presently claimed invention and a polyurethane formed with a comparative polyol.

FIG. 2A discloses the polyurethane foam prepared from comparative polyol having low green strength in the production line.

FIG. 2B discloses the polyurethane foam prepared from inventive polyol having higher green strength in the production line.

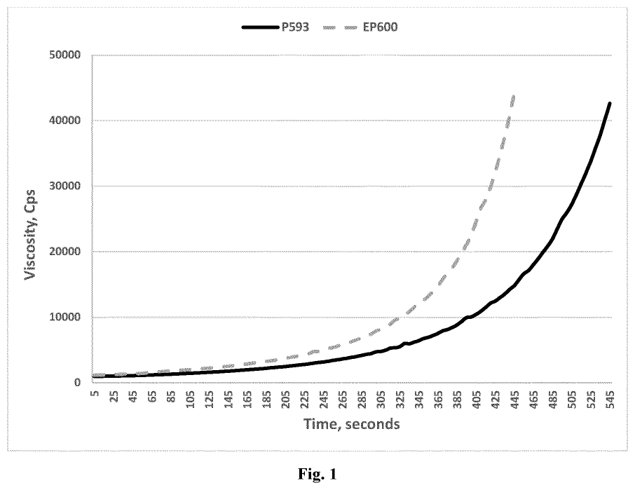

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In a first embodiment, the presently claimed invention is directed to a polyalkyleneoxy polyol (P) having an average nominal functionality in the range of 2 to 8;
a hydroxy number in the range of 10 to 500 mg KOH/g measured according to ASTM method D4272;
a weight average molecular weight in the range of 500 to 25000 measured using GPC with polystyrene standard and tetrahydrofuran as solvent;
wherein the polyol (P) comprises ethyleneoxy in an amount in the range of 50 to 95 wt. % based on overall weight of the polyol (P); and a primary hydroxy content is in the range of 30 to 65% based on total hydroxy content of polyol (P), more preferably the presently claimed invention is directed to a polyalkyleneoxy polyol (P) having an average nominal functionality in the range of 2 to 6;
a hydroxy number in the range of 10 to 300 mg KOH/g measured according to ASTM method D4272;
a weight average molecular weight in the range of 500 to 25000 measured using GPC with polystyrene standard and tetrahydrofuran as solvent;
wherein the polyol (P) comprises ethyleneoxy in an amount in the range of 50 to 95 wt. % based on overall weight of the polyol (P); and a primary hydroxy content is in the range of 30 to 50% based on total hydroxy content of polyol (P), even more preferably the presently claimed invention is directed to a polyalkyleneoxy polyol (P) having an average nominal functionality in the range of 3 to 6;
a hydroxy number in the range of 10 to 250 mg KOH/g measured according to ASTM method D4272;
a weight average molecular weight in the range of 1000 to 10000 measured using GPC with polystyrene standard and tetrahydrofuran as solvent;
wherein the polyol (P) comprises ethyleneoxy in an amount in the range of 60 to 90 wt. % based on overall weight of the polyol (P); and a primary hydroxy content is in the range of 35 to 50% based on total hydroxy content of polyol (P), most preferably the presently claimed invention is directed to a polyalkyleneoxy polyol (P) having an average nominal functionality in the range of >3 to <6;
a hydroxy number in the range of 10 to 250 mg KOH/g measured according to ASTM method D4272;
a weight average molecular weight in the range of 2000 to 8000 measured using GPC with polystyrene standard and tetrahydrofuran as solvent;
wherein the polyol (P) comprises ethyleneoxy in an amount in the range of 60 to 80 wt. % based on overall weight of the polyol (P); and a primary hydroxy content is in the range of 35 to 44% based on total hydroxy content of polyol (P), and in particular the presently claimed invention is directed to a polyalkyleneoxy polyol (P) having an average nominal functionality in the range of >3 to <5;
a hydroxy number in the range of 43 to 250 mg KOH/g measured according to ASTM method D4272;
a weight average molecular weight in the range of 3000 to 6000 measured using GPC with polystyrene standard and tetrahydrofuran as solvent;
wherein the polyol (P) comprises ethyleneoxy in an amount in the range of 70 to 80 wt. % based on overall weight of the polyol (P) and propyleneoxy in an amount in the range of 1 to 30 wt. % based on overall weight of the polyol(P); and a primary hydroxy content is in the range of 35 to 44% based on total hydroxy content of polyol (P).

In another preferred embodiment, the polyol (P) has an average nominal functionality in the range of 2 to 8, preferably the polyol (P) has an average nominal functionality in the range of 2 to 7, more preferably the polyol (P) has an average nominal functionality in the range of 3 to 7, even more preferably the polyol (P) has an average nominal functionality in the range of >3 to <6, most preferably the polyol (P) has an average nominal functionality in the range of >3 to <5, particular preferably the polyol (P) has an average nominal functionality in the range of >3 to <4, and even particular the polyol (P) has an average nominal functionality in the range of ≤3.2 to ≥3.8.

In another preferred embodiment, the polyol (P) has an average nominal functionality in the range of >3 to <7, more preferably the polyol (P) has an average nominal functionality in the range of >3 to <6, most preferably the polyol (P) has an average nominal functionality in the range of >3 to <5, and particular preferably the polyol (P) has an average nominal functionality in the range of >3 to <4.

In another preferred embodiment, the polyol (P) has a hydroxy number in the range of 10 to 400 mg KOH/g measured according to ASTM method D4272, preferably the polyol (P) has a hydroxy number in the range of 10 to 300 mg KOH/g measured according to ASTM method D4272, more preferably the polyol (P) has a hydroxy number in the range of 43 to 400 mg KOH/g measured according to ASTM method D4272, even more preferably the polyol (P) has a hydroxy number in the range of 43 to 300 mg KOH/g measured according to ASTM method D4272, most preferably the polyol (P) has a hydroxy number in the range of 43 to 100 mg KOH/g measured according to ASTM method D4272, particular preferably the polyol (P) has a hydroxy number in the range of 43 to 60 mg KOH/g measured according to ASTM method D4272, and in particular the polyol (P) has a hydroxy number in the range of 43 to 48 mg KOH/g measured according to ASTM method D4272.

In another preferred embodiment, the polyol (P) has a weight average molecular weight in the range of 1000 to 25000 measured using GPC with polystyrene standard and tetrahydrofuran as solvent, preferably the polyol (P) has a weight average molecular weight in the range of 1000 to 10000 measured using GPC with polystyrene standard and tetrahydrofuran as solvent, more preferably the polyol (P) has a weight average molecular weight in the range of 2000 to 8000 measured using GPC with polystyrene standard and tetrahydrofuran as solvent, even more the polyol (P) has a weight average molecular weight in the range of 2000 to 6000 measured using GPC with polystyrene standard and tetrahydrofuran as solvent, most preferably the polyol (P) has a weight average molecular weight in the range of 3000 to 6000 measured using GPC with polystyrene standard and tetrahydrofuran as solvent, in particular preferably the polyol (P) has a weight average molecular weight in the range of 3000 to 5500 measured using GPC with polystyrene standard and tetrahydrofuran as solvent and in particular the polyol (P) has a weight average molecular weight in the range of 3500 to 5500 measured using GPC with polystyrene standard and tetrahydrofuran as solvent.

In another preferred embodiment, ethyleneoxy is present in the polyol (P) in an amount in the range of 60 to 90 wt. % based on overall weight of the polyol (P), preferably ethyleneoxy is present in an amount in the range of 60 to 85 wt. % based on overall weight of the polyol (P), more preferably ethyleneoxy is present in an amount in the range of 65 to 85 wt. % based on overall weight of the polyol (P), even more preferably ethyleneoxy is present in an amount in the range of 65 to 80 wt. % based on overall weight of the polyol (P), most preferably ethyleneoxy is present in an amount in the range of 70 to 85 wt. % based on overall weight of the polyol (P), and in particular ethyleneoxy is present in an amount in the range of 70 to 80 wt. % based on overall weight of the polyol (P).

In another preferred embodiment, the polyol (P) further comprises at least one oxyalkylene moiety selected from propyleneoxy, or butyleneoxy and most preferably the polyol further comprises at least one propyleneoxy moiety.

Preferably the propyleneoxy moiety is derived from 1,2-propylene oxide or 1,3-propyleneoxide. More preferably, the propyleneoxy moiety is derived from 1,2-propyleen oxide.

Preferably the butyleneoxy moiety is derived from 1,2-butylene oxide, 1,3-butylene oxide and 2,3-epoxy butane.

In another preferred embodiment, the additional oxyalkylene in the polyol (P) is present in an amount in the range of 1 to 30 wt. % based on overall weight of the polyol (P), preferably the additional oxyalkylene in the polyol (P) is present in an amount in the range of 5 to 30 wt. % based on overall weight of the polyol, more preferably the additional oxyalkylene in the polyol is present in an amount in the range of 10 to 30 wt. % based on overall weight of the polyol, even more preferably the additional oxyalkylene in the polyol is present in an amount in the range of 15 to 30 wt. % based on overall weight of the polyol, most preferably the additional oxyalkylene in the polyol is present in an amount in the range of 20 to 30 wt. % based on overall weight of the polyol, and in particular the additional oxyalkylene in the polyol is present in an amount in the range of 22 to 28 wt. % based on overall weight of the polyol.

In another preferred embodiment, propylene oxide is present in the polyol (P) in an amount in the range of 1 to 40 wt. % based on overall weight of the polyol, preferably the propylene oxide is present in the polyol (P) in an amount in the range of 5 to 35 wt. % based on overall weight of the polyol (P), more preferably propylene oxide is present in the polyol (P) in an amount in the range of 5 to 30 wt. % based on overall weight of the polyol (P), even more preferably propylene oxide is present in the polyol (P) in an amount in the range of 10 to 30 wt. % based on overall weight of the polyol (P), most preferably propylene oxide is present in the polyol (P) in an amount in the range of 15 to 25 wt. % based on overall weight of the polyol (P), and in particular propylene oxide is present in the polyol (P) in an amount in the range of 20 to 30 wt. % based on overall weight of the polyol (P).

In another preferred embodiment, the polyol (P) derived has polyhydric alcohol is present in an amount in the range of 1 to 10 wt. %, ethylene oxide is present in an amount in the range of 60 to 90 wt. % and an additional oxyalkylene is present in an amount in the range of 0 to 30 wt. % based on overall weight of the polyol (P), preferably the polyol (P) derived has polyhydric alcohol is present in an amount in the range of 1 to 10 wt. %, ethylene oxide is present in an amount in the range of 60 to 85 wt. % and an additional oxyalkylene is present in an amount in the range of 1 to 30 wt. % based on overall weight of the polyol (P), more preferably the polyol (P) derived has polyhydric alcohol is present in an amount in the range of 1 to 10 wt. %, ethylene oxide is present in an amount in the range of 65 to 85 wt. % and an additional oxyalkylene is present in an amount in the range of 5 to 30 wt. % based on overall weight of the polyol (P), even more preferably the polyol (P) derived has polyhydric alcohol is present in an amount in the range of 1 to 5 wt. %, ethylene oxide is present in an amount in the range of 65 to 80 wt. % and an additional oxyalkylene is present in an amount in the range of 15 to 30 wt. % based on overall weight of the polyol (P), most preferably the polyol (P) derived has polyhydric alcohol is present in an amount in the range of 1 to 10 wt. %, ethylene oxide is present in an amount in the range of 70 to 85 wt. % and an additional oxyalkylene is present in an amount in the range of 20 to 30 wt. % based on overall weight of the polyol (P), and in particular the polyol (P) derived has polyhydric alcohol is present in an amount in the range of 1 to 5 wt. %, ethylene oxide is present in an amount in the range of 70 to 80 wt. % and an additional oxyalkylene is present in an amount in the range of 15 to 30 wt. % based on overall weight of the polyol (P).

In another preferred embodiment, the polyol (P) derived has polyhydric alcohol is present in an amount in the range of 1 to 10 wt. %, ethylene oxide is present in an amount in the range of 60 to 90 wt. % and propylene oxide is present in an amount in the range of 0 to 30 wt. % based on overall weight of the polyol (P), preferably the polyol (P) derived has polyhydric alcohol is present in an amount in the range of 1 to 10 wt. %, ethylene oxide is present in an amount in the range of 60 to 85 wt. % and propylene oxide is present in an amount in the range of 5 to 30 wt. % based on overall weight of the polyol (P), more preferably the polyol (P) derived has polyhydric alcohol is present in an amount in the range of 1 to 10 wt. %, ethylene oxide is present in an amount in the range of 65 to 85 wt. % and propylene oxide is present in an amount in the range of 10 to 30 wt. % based on overall weight of the polyol (P), even more preferably the polyol (P) derived has polyhydric alcohol is present in an amount in the range of 1 to 5 wt. %, ethylene oxide is present in an amount in the range of 65 to 80 wt. % and propylene oxide is present in an amount in the range of 15 to 30 wt. % based on overall weight of the polyol (P), most preferably the polyol (P) derived has polyhydric alcohol is present in an amount in the range of 1 to 10 wt. %, ethylene oxide is present in an amount in the range of 70 to 85 wt. % and propylene oxide is present in an amount in the range of 20 to 30 wt. % based on overall weight of the polyol (P), and in particular the polyol (P) derived has polyhydric alcohol is present in an amount in the range of 1 to 5 wt. %, ethylene oxide is present in an amount in the range of 70 to 80 wt. % and propylene oxide is present in an amount in the range of 15 to 30 wt. % based on overall weight of the polyol (P).

In another preferred embodiment, the polyol (P) derived has at least two polyhydric alcohol is present in an amount in the range of 1 to 10 wt. %, ethylene oxide is present in an amount in the range of 60 to 90 wt. % and an additional oxyalkylene is present in an amount in the range of 0 to 30 wt. % based on overall weight of the polyol (P), preferably the polyol (P) derived has at least two polyhydric alcohol is present in an amount in the range of 1 to 10 wt. %, ethylene oxide is present in an amount in the range of 60 to 85 wt. % and an additional oxyalkylene is present in an amount in the range of 1 to 30 wt. % based on overall weight of the polyol (P), more preferably the polyol (P) derived has at least two polyhydric alcohol is present in an amount in the range of 1 to 10 wt. %, ethylene oxide is present in an amount in the range of 65 to 85 wt. % and an additional oxyalkylene is present in an amount in the range of 5 to 30 wt. % based on overall weight of the polyol (P), even more preferably the polyol (P) derived has at least two polyhydric alcohol is present in an amount in the range of 1 to 5 wt. %, ethylene oxide is present in an amount in the range of 65 to 80 wt. % and an additional oxyalkylene is present in an amount in the range of 15 to 30 wt. % based on overall weight of the polyol (P), most preferably the polyol (P) derived has at least two polyhydric alcohol is present in an amount in the range of 1 to 10 wt. %, ethylene oxide is present in an amount in the range of 70 to 85 wt. % and an additional oxyalkylene is present in an amount in the range of 20 to 30 wt. % based on overall weight of the polyol (P), and in particular the polyol (P) derived has at least two polyhydric alcohol is present in an amount in the range of 1 to 5 wt. %, ethylene oxide is present in an amount in the range of 70 to 80 wt. % and an additional oxyalkylene is present in an amount in the range of 15 to 30 wt. % based on overall weight of the polyol (P).

In another preferred embodiment, the polyol (P) derived has at least two polyhydric alcohol is present in an amount in the range of 1 to 10 wt. %, ethylene oxide is present in an amount in the range of 60 to 90 wt. % and propylene oxide is present in an amount in the range of 0 to 30 wt. % based on overall weight of the polyol (P), preferably the polyol (P) derived has at least two polyhydric alcohol is present in an amount in the range of 1 to 10 wt. %, ethylene oxide is present in an amount in the range of 60 to 85 wt. % and propylene oxide is present in an amount in the range of 5 to 30 wt. % based on overall weight of the polyol (P), more preferably the polyol (P) derived has at least two polyhydric alcohol is present in an amount in the range of 1 to 10 wt. %, ethylene oxide is present in an amount in the range of 65 to 85 wt. % and propylene oxide is present in an amount in the range of 10 to 30 wt. % based on overall weight of the polyol (P), even more preferably the polyol (P) derived has at least two polyhydric alcohol is present in an amount in the range of 1 to 5 wt. %, ethylene oxide is present in an amount in the range of 65 to 80 wt. % and propylene oxide is present in an amount in the range of 15 to 30 wt. % based on overall weight of the polyol (P), most preferably the polyol (P) derived has at least two polyhydric alcohol is present in an amount in the range of 1 to 10 wt. %, ethylene oxide is present in an amount in the range of 70 to 85 wt. % and propylene oxide is present in an amount in the range of 20 to 30 wt. % based on overall weight of the polyol (P), and in particular the polyol (P) derived has at least two polyhydric alcohol is present in an amount in the range of 1 to 5 wt. %, ethylene oxide is present in an amount in the range of 70 to 80 wt. % and propylene oxide is present in an amount in the range of 15 to 30 wt. % based on overall weight of the polyol (P).

In another preferred embodiment, the polyol (P) according to anyone of the embodiments has primary hydroxy content in the range of 30 to 65% based on total hydroxy content of the polyol (P) as determined using ¹H NMR using AM-236, preferably the polyol (P) according to anyone of the embodiments has primary hydroxy content in the range of 30 to 55% based on total hydroxy content of the polyol (P) as determined using ¹H NMR using AM-236, more preferably the polyol (P) according to anyone of the embodiments has primary hydroxy content in the range of 30 to 50% based on total hydroxy content of the polyol (P) as determined using ¹H NMR using AM-236, even preferably the polyol (P) according to anyone of the embodiments has primary hydroxy content in the range of 35 to 50% based on total hydroxy content of the polyol (P) as determined using 1H NMR using AM-236, most preferably the polyol (P) according to anyone of the embodiments has primary hydroxy content in the range of 40 to 50% based on total hydroxy content of the polyol (P) as determined using ¹H NMR using AM-236, and in particular preferably the polyol (P) according to anyone of the embodiments has primary hydroxy content in the range of 40 to 44% based on total hydroxy content of the polyol (P) as determined using ¹H NMR using AM-236.

In another preferred embodiment, the polyol (P) according to anyone of the embodiments has primary hydroxy content derived from ethyleneoxy in the range of 30 to 65% and primary hydroxy content derived from propyleneoxy in the range of 0.01 to 10%, each based on total hydroxy content of the polyol (P) as determined using ¹H NMR using AM-236, preferably the polyol (P) according to anyone of the embodiments has primary hydroxy content derived from ethyleneoxy in the range of 30 to 55% and primary hydroxy content derived from propyleneoxy in the range of 1.0 to 8.0%, each based on total hydroxy content of the polyol (P) as determined using ¹H NMR using AM-236, more preferably the polyol (P) according to anyone of the embodiments has primary hydroxy content derived from ethyleneoxy in the range of 30 to 50% and primary hydroxy content derived from propyleneoxy in the range of 1.0 to 5.0%, each based on total hydroxy content of the polyol (P) as determined using ¹H NMR using AM-236, even preferably the polyol (P) according to anyone of the embodiments has primary hydroxy content derived from ethyleneoxy in the range of 35 to 45% and primary hydroxy content derived from propyleneoxy in the range of 1.0 to 4.0%, each based on total hydroxy content of the polyol (P) as determined using ¹H NMR using AM-236, most preferably the polyol (P) according to anyone of the embodiments has primary hydroxy content derived from ethyleneoxy in the range of 38 to 45% and primary hydroxy content derived from propyleneoxy in the range of 1.0 to 3.0%, each based on total hydroxy content of the polyol (P) as determined using ¹H NMR using AM-236, and in particular preferably the polyol (P) according to anyone of the embodiments has primary hydroxy content derived from ethyleneoxy in the range of 38 to 43% and primary hydroxy content derived from propyleneoxy in the range of 1.0 to 3.0%, each based on total hydroxy content of the polyol (P) as determined using ¹H NMR using AM-236.

In another preferred embodiment, the polyhydric alcohol according to presently claimed invention has nominal functionality 3, 4, 5, 6, 7 or 8, more preferably the polyhydric alcohol according to presently claimed invention has nominal functionality 3, 4, 5, 6, or 7, and most preferably the polyhydric alcohol according to presently claimed invention has nominal functionality 3, 4, 5, or 6.

In another preferred embodiment, the polyol (P) has viscosity in the range of 850 to 2000 cP at 25° C. measured using an LV-3 spindle, preferably the polyol (P) has viscosity in the range of 900 to 1800 cP at 25° C. measured using an LV-3 spindle, more the polyol (P) has viscosity in the range of 900 to 1500 cP at 25° C. measured using an LV-3 spindle, even more the polyol (P) has viscosity in the range of 900 to 1400 cP at 25° C. measured using an LV-3 spindle, most preferably the polyol (P) has viscosity in the range of 900 to 1300 cP at 25° C. measured using an LV-3 spindle, in particular the polyol (P) has viscosity in the range of 900 to 1200 cP at 25° C. measured using an LV-3 spindle, and in particular the polyol (P) has viscosity in the range of 900 to 1150 cP at 25° C. measured using an LV-3 spindle.

In another preferred embodiment, the polyol (P) is a random copolymer of ethylene oxide and at least one alkyleneoxide other than ethylene oxide, more preferably the polyol (P) is a random copolymer of ethylene oxide and propylene oxide, and most preferably the polyol (P) is a random copolymer of ethylene oxide and 1,2-propylene oxide.

In another embodiment, the presently claimed invention is directed to a process for preparing a polyalkyleneoxy polyol (P) comprising the steps of:
i. providing at least one polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product; preferably the process for preparing a polyalkyleneoxy polyol (P) comprising the steps of:
   i. providing at least one polyhydric alcohol;
   ii. heating the polyhydric alcohol to a temperature in the range of 50 to 250° C.;
   iii. providing a feed comprising ethylene oxide to the heated polyhydric alcohol of step ii.; and
   iv. obtaining the polyalkyleneoxy polyol product; more preferably the process for preparing a polyalkyleneoxy polyol (P) comprising the steps of:
   i. providing at least two polyhydric alcohol;
   ii. heating the polyhydric alcohol to a temperature in the range of 50 to 250° C.;
   iii. providing a feed comprising ethylene oxide to the heated polyhydric alcohol of step ii.; and
   iv. obtaining the polyalkyleneoxy polyol product; most preferably process for preparing a polyalkyleneoxy polyol (P) comprising the steps of:
   i. providing at least two polyhydric alcohol;
   ii. heating the polyhydric alcohol to a temperature in the range of 50 to 200° C.;
   iii. providing a feed comprising ethylene oxide to the heated polyhydric alcohol of step ii.; and
   iv. obtaining the polyalkyleneoxy polyol product; and in particular the process for preparing a polyalkyleneoxy polyol (P) comprising the steps of:
   i. providing at least two polyhydric alcohol;
   ii. heating the polyhydric alcohol to a temperature in the range of 80 to 200° C.;
   iii. providing a feed comprising ethylene oxide and propylene oxide to the heated polyhydric alcohol of step ii.; and
   iv. obtaining the polyalkyleneoxy polyol product.

In another preferred embodiment, the at least one or at least two polyhydric alcohol is selected from ethylene glycol, diethylene glycol, triethylene glycol, O,O′-bis (2-hydroxypropyl) ethylene glycol, propylene glycol, dipropylene glycol, tripropylene glycol, glycerine, trimethylolpropane, pentaerythritol, sorbitol, sucrose, N,N,N′,N′-tetrakis [2-hydroxyethyl] ethylene diamine, N,N,N′,N′-tetrakis [2-hydroxypropyl] ethylene diamine; or N,N-bis[2-hydroxyethyl] aniline, more preferably the at least one or at least two polyhydric alcohol is selected from ethylene glycol, diethylene glycol, triethylene glycol, O,O′-bis (2-hydroxypropyl) ethylene glycol, propylene glycol, dipropylene glycol, tripropylene glycol, glycerine, trimethylolpropane, pentaerythritol, sorbitol, sucrose, N,N,N′,N′-tetrakis [2-hydroxyethyl] ethylene diamine, or N,N,N′,N′-tetrakis [2-hydroxypropyl] ethylene diamine, even more preferably the at least one or at least two polyhydric alcohol is selected from ethylene glycol, diethylene glycol, triethylene glycol, O,O′-bis (2-hydroxypropyl) ethylene glycol, propylene glycol, dipropylene glycol, tripropylene glycol, glycerine, trimethylolpropane, pentaerythritol, sorbitol, sucrose, or N,N,N′,N′-tetrakis [2-hydroxyethyl] ethylene diamine, and most preferably the at least one or at least two polyhydric alcohol is selected from ethylene glycol, diethylene glycol, propylene glycol, dipropylene glycol, glycerine, or sorbitol.

In another preferred embodiment, the total amount of at least one or at least two polyhydric alcohol provided in step i. is in the range of 1 to 10 wt. % based on the total weight of the reactive components, more preferably the total amount of polyhydric alcohol provided in step i. is in the range of 1 to 9 wt. % bases on total weight of the reactive components, even more preferable the total amount of at least one or at least two polyhydric alcohol provided in step i. is in the range of 2 to 9 wt. % bases on total weight of the reactive components, most preferably the total amount of at least one or at least two polyhydric alcohol provided in step i. is in the range of 3 to 9 wt. % bases on total weight of the reactive components, in particular preferably the total amount of at least one or at least two polyhydric alcohol provided in step i. is in the range of 3 to 8 wt. % bases on total weight of the reactive components, and in particular the total amount of polyhydric alcohol in step i. is tin the range of 3 to 7 wt. % bases on total weight of the reactive components, wherein each case reactive components are polyhydric alcohol(s) and the alkylene oxide component.

In another preferred embodiment the temperature in step ii. is in the range of 80 to 200° C., more preferably the temperature in step ii. is in the range of 80 to 180° C., even more preferably the temperature in step ii. is in the range of 80 to 150° C., most preferably the temperature in step ii. is in the range of 90 to 140° C. and in particular the temperature in step ii. is in the range of 90 to 130° C.

In another preferred embodiment the feed in step iii. comprises ethylene oxide in an amount in the range of 60 to 99 wt. % based on total weight of the feed components, preferably the feed comprises ethylene oxide in amount in the range of 60 to 95 wt. % based on total weight of the feed components, more preferably the feed comprises ethylene oxide in amount in the range of 65 to 95 wt. % based on total weight of the feed components, even more preferably the feed comprises ethylene oxide in amount in the range of 70 to 90 wt. % based on total weight of the feed components, most preferably the feed comprises ethylene oxide in amount in the range of 70 to 85 wt. % based on total weight of the feed components, and in particular the feed comprises ethylene oxide in amount in the range of 70 to 80 wt. % based on total weight of the feed components.

In another preferred embodiment the feed provided in step iii. further comprises at least one alkyleneoxide selected from propyleneoxide, or butyleneoxide is present in amount in the range of 1 to 40 wt. % bases on total weight of the feed, preferably the feed provided in step iii. further comprises at least one alkyleneoxide selected from propyleneoxide or butyleneoxide is present in amount in the range of 1 to 35 wt. % bases on total weight of the feed, more preferably the feed provided in step iii. further comprises at least one alkyleneoxide selected from propyleneoxide, or butyleneoxide is present in amount in the range of 5 to 35 wt. % bases on total weight of the feed, even more preferably the feed provided in step iii. further comprises at least one alkyleneoxide selected from propyleneoxide or butyleneoxide is present in amount in the range of 5 to 30 wt. % bases on total weight of the feed, most preferably the feed provided in step iii. further comprises at least one alkyleneoxide selected from propyleneoxide or butyleneoxide is present in amount in the range of 10 to 30 wt. % bases on total weight of the feed, and in particular the feed provided in step iii. further comprises propyleneoxide is present in amount in the range of 15 to 30 wt. % bases on total weight of the feed.

The term “reactive components” refers to the polyhydric alcohol(s) and the reactive alkylene oxides employed in the inventive process. The total weight of the reactive components therefore refers to the total amount of polyhydric alcohol(s) and the total amount of reactive alkylene oxides employed in the inventive process.

In another preferred embodiment, the process for the preparation of the polyol (P) is conducted at a pressure in the range of 10 to 350 psi, preferably, the process for the preparation of the polyol (P) is conducted at a pressure in the range of 20 to 250 psi, more preferably the process for the preparation of the polyol (P) is conducted at a pressure in the range of 30 to 200 psi, even more preferably the process for the preparation of the polyol (P) is conducted at a pressure in the range of 40 to 160 psi, most preferably the process for the preparation of the polyol (P) is conducted at a pressure in the range of 50 to 150 psi, in particular the process for the preparation of the polyol (P) is conducted at a pressure in the range of 60 to 130 psi, and even particular the process for the preparation of the polyol (P) is conducted at a pressure in the range of 70 to 120 psi.

In another embodiment presently claimed invention is directed to a polyol (P) obtained by a process comprising the steps of:
i. providing at least one polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product,

wherein the polyol (P) has polyhydric alcohol is present in an amount in the range of 1 to 10 wt. %, and ethylene oxide is present in an amount in the range of 60 to 99 wt. %, and an additional alkylene oxide is present in an amount in the range of 0 to 30 wt. % each based on overall weight of the polyol (P).

Preferably, presently claimed invention is directed to a polyol (P) obtained by a process comprising the steps of:
i. providing at least one polyhydric alcohol;
ii. heating the polyhydric alcohol to a temperature in the range of 50 to 250° C.;
iii. providing a feed comprising ethylene oxide to the heated polyhydric alcohol of step ii.; and
iv. obtaining the polyalkyleneoxy polyol product,

wherein polyol (P) has polyhydric alcohol is present in an amount in the range of 1 to 10 wt. %, ethylene oxide is present in an amount in the range of 65 to 99 wt. %, and an additional alkylene oxide is present in an amount in the range of 0 to 30 wt. % each based on overall weight of the polyol (P).

More preferably, the presently claimed invention is directed to a polyol (P) obtained by a process comprising the steps of:
i. providing at least two polyhydric alcohol;
ii. heating the polyhydric alcohol to a temperature in the range of 50 to 250° C.;
iii. providing a feed comprising ethylene oxide and an additional alkylene oxide to the heated polyhydric alcohol of step ii.; and
iv. obtaining the polyalkyleneoxy polyol (P) product;

wherein the polyol (P) derived has polyhydric alcohol is present in an amount in the range of 1 to 5 wt. %, ethylene oxide is present in an amount in the range of 65 to 85 wt. % and an additional alkylene oxide is present in an amount in the range of 10 to 30 wt. % based on overall weight of the polyol (P).

Most preferably, the presently claimed invention is directed to a polyol (P) obtained by a process comprising the steps of:
i. providing at least two polyhydric alcohol;
ii. heating the polyhydric alcohol to a temperature in the range of 50 to 200° C.;
iii. providing a feed comprising ethylene oxide and an additional alkylene oxide to the heated polyhydric alcohol of step ii.; and
iv. obtaining the polyalkyleneoxy polyol product;

wherein the polyol (P) derived has polyhydric alcohol is present in an amount in the range of 1 to 5 wt. %, ethylene oxide is present in an amount in the range of 70 to 80 wt. % and an additional alkylene oxide is present in an amount in the range of 15 to 30 wt. % based on overall weight of the polyol (P).

In particular, the presently claimed invention is directed to a polyol (P) obtained by a process comprising the steps of:
i. providing at least two polyhydric alcohol;
ii. heating the polyhydric alcohol to a temperature in the range of 80 to 200° C.;
iii. providing a feed comprising ethylene oxide and propylene oxide to the heated polyhydric alcohol of step ii.; and
iv. obtaining the polyalkyleneoxy polyol product.

wherein the polyol (P) derived has polyhydric alcohol is present in an amount in the range of 1 to 5 wt. %, ethylene oxide is present in an amount in the range of 65 to 80 wt. % and propylene oxide is present in an amount in the range of 15 to 30 wt. % based on overall weight of the polyol (P).

In another embodiment, the presently claimed invention is directed to a polyurethane copolymer obtained by reacting a reaction mixture comprising:
i. at least one isocyanate (A); and
ii. at least one polyol (P) as described above.

In another preferred embodiment, the at least one isocyanate (A) is selected from aliphatic isocyanate, or aromatic isocyanate.

In another preferred embodiment, the aliphatic isocyanate is selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, cyclohexyldiisocyanate, decamethylene-1,10-diisocyanate, 2,11-diisocyanato-dodecane, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)(CH₂)₃NCO, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, (2,4,6-trioxotriazine-1,3,5(2h,4h,6h)-triyhtris(hexamethylene) isocyanate, 3,3′,3″-[(1h,3h,5h)-2,4,6-trioxo-1,3,5-triazine-1,3,5-triyltris(methylene)]tris[3,5,5-trimethylcyclohexyl] triisocyanate, 2,4,4′-triisocyanato-dicyclohexylmethane, or polymeric forms of diisocyanates and triisocyanates, more preferably the aliphatic isocyanate selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, cyclohexyldiisocyanate, nonamethylene diisocyanate, 2,2,4-trimethylhexamethylene-1,6-diisocyanate, decamethylene-1,10-diisocyanate, 2,11-diisocyanato-dodecane1,2-bis (3-isocyanato-propoxy)ethane, 2,2-dimethyl propylene diisocyanate, 3-methoxy hexamethylene-1,6-diisocyanate, 2,5-d imethyl heptamethylene diisocyanate, 5-methyl nonamethylene-1,9-diisocyanate, 1,4-diisocyanato cyclohexane, 1,2-diisocyanato octadecane, or polymeric forms of diisocyanates and triisocyanates, most preferably the aliphatic isocyanate selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 1,2-diisocyanato octadecane, or polymeric forms of diisocyanates and triisocyanates, and in particular the aliphatic isocyanate selected from isophorone diisocyanate, hexamethylene-1,6-diisocyanate, 2-methylpentamethylene-1,5-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 1,2-diisocyanato octadecane, or polymeric forms of diisocyanates and triisocyanates.

In another preferred embodiment, the aromatic isocyanate is selected from meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate,1,5-naphthalene diisocyanate; 4-chloro-1; 3-phenylene diisocyanate; methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene diphenyl isocyanate (MDI), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, 1,3,5-triazine-2,4,6-triisocyanate, triisocyanate triphenylthiophosphate, 2,4,4′-diphenylether triisocyanate or polymeric forms of diisocyanates and triisocyanates, more preferably the aromatic isocyanate selected from meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate,1,5-naphthalene diisocyanate; 2,2′-biphenylene diisocyanate, 3,3′-biphenylene diisocyanate, 4,4′-biphenylene diisocyanate, methylene diphenyl isocyanate (MDI), ethylene-bis(4-phenyl isocyanate), isopropylidene-bis(4-phenyl isocyanate), butylene-bis(4-phenylisocyanate), 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, or polymeric forms of diisocyanates and triisocyanates, even more preferably the aromatic isocyanate selected from meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, methylene diphenyl isocyanate (MDI), 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, or polymeric forms of diisocyanates and triisocyanates, most preferably the aromatic isocyanate selected from toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, methylene diphenyl isocyanate (MDI), 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, or polymeric forms of diisocyanates and triisocyanates, and in particular the aromatic isocyanate selected from toluene-2,4-diisocyanate, toluene-2,6-diisocyanate, xylene-2,4-diisocyanate, xylene-2,6-diisocyanate, methylene diphenyl isocyanate (MDI), or polymeric forms of the above diisocyanates.

In another preferred embodiment, the isocyanate is selected from isophorone diisocyanate, hexamethylene diisocyanate, 2-methylpentamethylene diisocyanate, pentamethylene diisocyanate, octamethylene diisocyanate, 2,4,4-trimethylhexamethylene-1,6-diisocyanate, cyclohexyl diisocyanate, decamethylene-1,10-diisocyanate, toluene diisocyanate, MDI, phenylene diisocyanate, xylene diisocyanate, biphenylene diisocyanate, or oxydiphenyl diisocyanate, more preferably the isocyanate is selected from isophorone diisocyanate, hexamethylene diisocyanate, pentamethylene diisocyanate, octamethylene diisocyanate, cyclohexyl diisocyanate, decamethylene-1,10-diisocyanate, toluene diisocyanate, MDI, phenylene diisocyanate, xylene diisocyanate, biphenylene diisocyanate, or oxydiphenyl diisocyanate, most preferably the isocyanate is selected from isophorone diisocyanate, hexamethylene diisocyanate, penta methylene diisocyanate, octamethylene diisocyanate, cyclohexyl diisocyanate, decamethylene-1,10-diisocyanate, toluene diisocyanate, MDI, phenylene diisocyanate, xylene diisocyanate, or biphenylene diisocyanate, and in particular the isocyanate is selected from toluene diisocyanate, or MDI.

In another preferred embodiment, the MDI is selected from 2,4′-diphenylmethane diisocyanate (2,4′-MDI), a modified isocyanate different from the 2,4′-MDI, 4,4′-diphenylmethane diisocyanate (4,4′-MDI), a modified isocyanate different from the 4,4′-MDI, polymethylene polyphenyl polyisocyanate (PMDI), and combinations thereof.

In another preferred embodiment, the isocyanate is selected from the group of 2,4′-MDI, 4,4′-MDI, a modified isocyanate different from the 2,4′-MDI and the 4,4′-MDI, PMDI, or combinations thereof. In another preferred embodiment, the modified isocyanate comprises a uretonimine. The modified isocyanate comprising a uretonimine is hereinafter referred to as uretonimine-modified isocyanate. Uretonimine-modified isocyanates are also known as carbodiimide-modified isocyanates in the art.

In another preferred embodiment, the isocyanate comprises 2,4′-MDI and 4,4′-MDI with the 2,4′-MDI present in an amount of from about 10 to about 55 parts by weight based on 100 parts by weight of the isocyanate, or any range between the lowest and highest of these values, and the 4,4′-MDI present in an amount of from about 45 to about 90 parts by weight based on 100 parts by weight of the isocyanate, or any range between the lowest and highest of these values.

In another preferred embodiment, the isocyanate comprises the modified isocyanate and 4,4′-MDI with the modified isocyanate present in an amount of from about 15 to about 35 parts by weight based on 100 parts by weights of the isocyanate, or any range between the lowest and highest of these values, and the 4,4′-MDI present in an amount of from about 65 to about 85 parts by weight based on 100 parts by weight of the isocyanate, or any range between the lowest and highest of these values.

In another embodiment, the isocyanate comprises PMDI and 4,4′-MDI with the PMDI present in an amount of from about 30 to about 75 parts by weight based on 100 parts by weight of the isocyanate, or any range between the lowest and highest of these values, and the 4,4′-MDI present in an amount of from about 20 to about 70 parts by weight based on 100 parts by weight of the isocyanate, or any range between the lowest and highest of these values. The terminology “present”, as used herein with reference to the amounts in the isocyanate, may be prior to the formation of the reaction product, during the reaction, or after formation of the reaction product.

In another preferred embodiment, the at least one isocyanate described above may be present in the form of a dimer, a trimer or an oligomer containing a urethane group, an isocyanurate group, a biuret group, an uretdione group, an allophanate group and/or an iminooxadiazinedione group.

In another embodiment, the presently claimed invention is directed to a process for preparing a polyurethane copolymer comprising at least the steps of:
i. providing at least one isocyanate (A);
ii. providing at least one polyol (P) as described above; and
iii. reacting (A) and (P); more preferably the process for preparing a polyurethane copolymer comprises at least the steps of:
i. providing at least one isocyanate (A) selected from aliphatic isocyanate, and/or aromatic isocyanate;

providing at least one polyol (P) having an average nominal functionality in the range of 2 to 8; a hydroxy number in the range of 10 to 500 mg KOH/g measured according to ASTM method D4272; a weight average molecular weight in the range of 500 to 25000 measured using GPC with polystyrene standard and tetrahydrofuran as solvent; wherein the polyol (P) comprises ethyleneoxy in an amount in the range of 50 to 95 wt. % based on overall weight of the polyol (P), and a primary hydroxy content is in the range of 30 to 65% based on total hydroxy content of polyol (P); and
ii. reacting (A) and (P); even more preferably the process for preparing a polyurethane copolymer comprising at least the steps of:
i. providing at least one isocyanate (A) selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, cyclohexyldiisocyanate, decamethylene-1,10-diisocyanate, 2,11-diisocyanato-dodecane, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)(CH₂)₃NCO, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, (2,4,6-trioxotriazine-1,3,5(2h,4h,6h)-triyhtris(hexamethylene) isocyanate, 3,3′,3″-[(1h,3h,5h)-2,4,6-trioxo-1,3,5-triazine-1,3,5-triyltris(methylene)]tris[3,5,5-trimethylcyclohexyl] triisocyanate, 2,4,4′-triisocyanato-dicyclohexylmethane, or polymeric forms of diisocyanates and triisocyanates, more preferably the aliphatic isocyanate selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, cyclohexyldiisocyanate, nonamethylene diisocyanate, 2,2,4-trimethylhexamethylene-1,6-diisocyanate, decamethylene-1,10-diisocyanate, 2,11-diisocyanato-dodecane1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, or polymeric forms of diisocyanates and triisocyanates, most preferably the aliphatic isocyanate selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 1,2-diisocyanato octadecane, and polymeric forms of diisocyanates and triisocyanates, and in particular the aliphatic isocyanate selected from isophorone diisocyanate, hexamethylene-1,6-diisocyanate, 2-methylpentamethylene-1,5-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 1,2-diisocyanato octadecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate,1,5-naphthalene diisocyanate; 4-chloro-1; 3-phenylene diisocyanate; methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene diphenyl isocyanate (MDI), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, 1,3,5-triazine-2,4,6-triisocyanate, triisocyanate triphenylthiophosphate, 2,4,4′-diphenylether triisocyanate or polymeric forms of diisocyanates and triisocyanates, more preferably the aromatic isocyanate selected from meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate,1,5-naphthalene diisocyanate; 2,2′-biphenylene diisocyanate, 3,3′-biphenylene diisocyanate, 4,4′-biphenylene diisocyanate, methylene diphenyl isocyanate (MDI), ethylene-bis(4-phenyl isocyanate), isopropylidene-bis(4-phenyl isocyanate), butylene-bis(4-phenylisocyanate), 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, or polymeric forms of diisocyanates and triisocyanates, even more preferably the aromatic isocyanate selected from meta-phenylene diisocyanate, para-phenylene diisocyanate, toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, methylene diphenyl isocyanate (MDI), 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, or polymeric forms of diisocyanates and triisocyanates, most preferably the aromatic isocyanate selected from toluene-2,4-diisocyanate, toluene-2,6-diisocyanate, xylene-2,4-diisocyanate, xylene-2,6-diisocyanate, 2,2′-biphenylene diisocyanate, 3,3′-biphenylene diisocyanate, 4,4′-biphenylene diisocyanate, methylene diphenyl isocyanate (MDI), 2, 4-bis(b-isocyanato-t-butyl)toluene, bis(para-b-isocyanato-t-butyl-phenyl)ether, para-bis(2-methyl-4-isocyanatophenyl)benzene, triphenylmethane-4,4′,4″-triisocyanate, toluene-2,4,6-triyl triisocyanate, or polymeric forms of diisocyanates and triisocyanates, and in particular the aromatic isocyanate selected from toluene-2,4-diisocyanate, toluene-2,6-diisocyanate, xylene-2,4-diisocyanate, xylene-2,6-diisocyanate, methylene diphenyl isocyanate (MDI), or polymeric forms of the above isocyanates;
providing at least one polyol (P) having an average nominal functionality in the range of 2 to 8; a hydroxy number in the range of 10 to 500 mg KOH/g measured according to ASTM method D4272; a weight average molecular weight in the range of 500 to 25000 measured using GPC with polystyrene standard and tetrahydrofuran as solvent; wherein the polyol (P) comprises ethyleneoxy in an amount in the range of 50 to 95 wt. % based on overall weight of the polyol (P), and a primary hydroxy content is in the range of 30 to 65% based on total hydroxy content of polyol (P); and
ii. reacting (A) and (P); most preferably the process for preparing a polyurethane copolymer comprising at least the steps of:
   i. providing at least one isocyanate (A) selected from isophorone diisocyanate, hexamethylene diisocyanate, 2-methylpentamethylene diisocyanate, pentamethylene diisocyanate, octamethylene diisocyanate, 2,4,4-trimethylhexamethylene-1,6-diisocyanate, cyclohexyl diisocyanate, decamethylene-1,10-diisocyanate, toluene diisocyanate, MDI, phenylene diisocyanate, xylene diisocyanate, biphenylene diisocyanate, or oxydiphenyl diisocyanate;
providing at least one polyol (P) having an average nominal functionality in the range of >3 to <5; a hydroxy number in the range of 43 to 250 mg KOH/g measured according to ASTM method D4272; a weight average molecular weight in the range of 2000 to 10000 measured using GPC with polystyrene standard and tetrahydrofuran as solvent; wherein the polyol (P) comprises ethyleneoxy in an amount in the range of 60 to 80 wt. % based on overall weight of the polyol (P), and a primary hydroxy content is in the range of 30 to 65% based on total hydroxy content of polyol (P); and
   ii. reacting (A) and (P); and in particular the process for preparing a polyurethane copolymer comprising at least the steps of:
   i. providing at least one isocyanate (A) selected from isophorone diisocyanate, hexamethylene 2,4,4-trimethylhexamethylene-1,6-diisocyanate, cyclohexyl diisocyanate, toluene diisocyanate, MDI, phenylene diisocyanate, biphenylene diisocyanate, or oxydiphenyl diisocyanate;
providing at least one polyol (P) having an average nominal functionality in the range of 3.2 to 3.8; a hydroxy number in the range of 43 to 250 mg KOH/g measured according to ASTM method D4272; a weight average molecular weight in the range of 3000 to 6000 measured using GPC with polystyrene standard and tetrahydrofuran as solvent; wherein the polyol (P) comprises ethyleneoxy in an amount in the range of 70 to 80 wt. % based on overall weight of the polyol (P), and a primary hydroxy content is in the range of 30 to 65% based on total hydroxy content of polyol (P); and
   ii. reacting (A) and (P).

In another preferred embodiment, the molar ratio of NCO in the total amount of isocyanate (A) to the at least one polyol (P) is in the range of ≥1.0:10 to ≤10:1.0, more preferably the molar ratio of NCO in the total amount of isocyanate (A) to the at least one polyol (P) is in the range of ≥1.0:8 to ≤8:1.0, most preferably the molar ratio of NCO in the total amount of isocyanate (A) to the at least one polyol (P) is in the range of ≥1.0:5 to ≤5:1.0, in particular preferably the molar ratio of NCO in total amount of isocyanate (A) to the at least one polyol (P) is in the range of ≥1.0:2.5 to ≤2.5:1.0 and in particular preferably the molar ratio of NCO in the total amount of isocyanate (A) to the at least one polyol (P) is in the range of ≥1.0:2.0 to ≤2.0:1.0.

In another preferred embodiment, the step iii) is carried out at a temperature in the range of ≥−50° C. to ≤250° C., more preferably, the step iii) is carried out at a temperature in the range of ≥0° C. to ≤200° C., even more preferably, the step iii) is carried out at a temperature in the range of ≥10° C. to ≤150° C., most preferably, the step iii) is carried out at a temperature in the range of ≥20° C. to ≤100° C., and in particular the step iii) is carried out at a temperature in the range of ≥20° C. to ≤80° C.

In another embodiment the presently claimed invention is directed to an article comprising a polyurethane copolymer obtained as described above, preferably a foamed article.

In the following, there is provided a list of embodiments to further illustrate the present disclosure without intending to limit the disclosure to the specific embodiments listed below.

In another embodiment, the presently claimed invention is directed to a polyol (P) obtained by a process comprising the steps of:
i. providing at least one or at least two polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product,

wherein the polyol (P) having an average nominal functionality in the range of 2 to 8; a hydroxy number in the range of 43 to 500 mg KOH/g measured according to ASTM method D4272; a weight average molecular weight in the range of 500 to 25000 measured using GPC with polystyrene standard and tetrahydrofuran as solvent; wherein the polyol (P) comprises ethyleneoxy in an amount in the range of 50 to 95 wt. % based on overall weight of the polyol (P), more preferably the presently claimed invention is directed to a polyol (P) obtained by a process comprising the steps of:
i. providing at least one or at least two polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product,

wherein the polyol (P) having an average nominal functionality in the range of 2 to 8; a hydroxy number in the range of 43 to 500 mg KOH/g measured according to ASTM method D4272; a weight average molecular weight in the range of 500 to 25000 measured using GPC with polystyrene standard and tetrahydrofuran as solvent; wherein the polyol (P) comprises ethyleneoxy in an amount in the range of 50 to 95 wt. % based on overall weight of the polyol (P), and a primary hydroxy content is in the range of 30 to 65% based on total hydroxy content of polyol (P).

### EMBODIMENTS

1. A polyalkyleneoxy polyol (P) having an average nominal functionality in the range of 2 to 8; a hydroxy number in the range of 10 to 500 mg KOH/g measured according to ASTM method D4272;
a weight average molecular weight in the range of 500 to 25000 measured using GPC with polystyrene standard and tetrahydrofuran as solvent;

wherein the polyol comprises ethyleneoxy in an amount in the range of 50 to 95 wt. % based on overall weight of the polyol (P), and a primary hydroxy content is in the range of 30 to 65% based on total hydroxy content of polyol (P).
2. The polyol according to embodiment 1, wherein the polyol has an average nominal functionality in the range of >3 to <6.
3. The polyol according to embodiment 2, wherein the polyol has an average nominal functionality in the range of ≥3.1 to ≤5.
4. The polyol according to embodiment 3, wherein the polyol has an average nominal functionality in the range of ≥3.2 to ≤4.
5. The polyol according to any one of the embodiments 1 to 4, wherein the polyol has a hydroxy number in the range of 43 to 300 mg KOH/g measured according to ASTM method D4272.
6. The polyol according to embodiment 5, wherein the polyol has a hydroxy number in the range of 43 to 100 mg KOH/g measured according to ASTM method D4272.
7. The polyol according to any one of the embodiments 1 to 6, wherein the polyol has a weight average molecular weight in the range of 1000 to 10000 measured using GPC with polystyrene standard and tetrahydrofuran as solvent.
8. The polyol according to embodiment 7, wherein the polyol has a weight average molecular weight in the range of 2000 to 6000 measured using GPC with polystyrene standard and tetrahydrofuran as solvent.
9. The polyol according to embodiment 8, wherein the polyol has a weight average molecular weight in the range of 3000 to 6000 measured using GPC with polystyrene standard and tetrahydrofuran as solvent.
10. The polyol according to any one of the embodiments 1 to 9, wherein the ethyleneoxy is present in an amount in the range of 60 to 90 wt. % based on overall weight of the polyol.
11. The polyol according to embodiment 10, wherein the ethyleneoxy is present in an amount in the range of 65 to 90 wt. % based on the overall weight of the polyol.
12. The polyol according to embodiment 11, wherein the ethyleneoxy is present in an amount in the range of 65 to 80 wt. % based on the overall weight of the polyol.
13. The polyol according to embodiment 12, wherein the polyol has ethyleneoxy is present in an amount in the range of 70 to 80 wt. % based on the overall weight of the polyol.
14. The polyol according to any one of the embodiments 1 to 13 further comprises at least one oxyalkylene moieties selected from propyleneoxy, or butyleneoxy.
15. The polyol according to embodiment 14, wherein the at least one oxyalkylene moiety is propyleneoxy.
16. The polyol according to any one of the embodiments 14 to 15, wherein the oxyalkylene moiety according to any one of the embodiments 14 to 15 is present in an amount in the range of 1 to 40 wt. % based on overall weight of the polyol.
17. The polyol according to embodiment 16, wherein the oxyalkylene moiety is propyleneoxy present in an amount in the range of 1 to 40 wt. % based on overall weight of the polyol.
18. The polyol according to embodiment 17, wherein the propyleneoxy is present in an amount in the range of 5 to 30 wt. % based on the overall weight of the polyol.
19. The polyol according to embodiment 18, wherein the propyleneoxy is present in an amount in the range of 10 to 30 wt. % based on the overall weight of the polyol.
20. The polyol according to any one of the embodiments 1 to 19 wherein the polyol has viscosity in the range of 850 to 2000 cP at 25° C. measured using an LV-3 spindle.
21.A process for preparing a polyalkyleneoxy polyol according to any of the embodiments 1 to 20 comprising the steps of:
i. providing at least one or at least two polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product.
22. The process according to embodiment 21, wherein the at least one or at least two polyhydric alcohol is selected from ethylene glycol, diethylene glycol, triethylene glycol, 0,0′-bis (2-hydroxypropyl) ethylene glycol, propylene glycol, dipropylene glycol, tripropylene glycol, glycerine, trimethylolpropane, pentaerythritol, sorbitol, sucrose, N,N,N′,N′-tetrakis [2-hydroxyethyl] ethylene diamine, N,N,N′,N′-tetrakis [2-hydroxypropyl] ethylene diamine; or N,N-bis[2-hydroxyethyl] aniline.
23. The process according to embodiment 22, wherein the polyhydric alcohol is selected from ethylene glycol, diethylene glycol, propylene glycol, dipropylene glycol, glycerine or sorbitol.
24. The process according to any of the embodiments 21 to 23, wherein in the step ii. the temperature is in the range of 80 to 200° C.
25. The process according to any of the embodiments 21 to 24, wherein the feed comprises ethylene oxide in amount in the range of 60 to 99 wt. % based on total weight of the feed.
26. The process according to any of the embodiments 21 to 25, wherein the feed provided in step iii. further comprises at least one oxyalkylene moieties selected from propyleneoxy, or butyleneoxy is present in amount in the range of 1 to 40 wt. % bases on total weight of the feed.
27. A polyurethane copolymer obtained by reacting a reaction mixture comprising:
i. at least one isocyanate (A); and
ii. at least one polyol (P) according any one of the embodiments 1 to 20.
28. The polyurethane according to embodiment 27, wherein at least one isocyanate (A) is selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyhtris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate or polymeric forms of diisocyanates and triisocyanates.
29. The polyurethane copolymer according to any of the embodiments 27 to 28, wherein the at least one isocyanate is present in the form of a dimer, a trimer or an oligomer containing a urethane group, an isocyanurate group, a biuret group, an uretdione group, an allophanate group and/or an iminooxadiazinedione group.
30. The polyurethane copolymer according to any of the embodiments 27 to 29, wherein the molar ratio of NCO in the isocyanate (A) to the polyol (P) is in the range of 1.0:10 to 10:1.0.
31. The polyurethane copolymer according to any of the embodiments 27 to 30, wherein the molar ratio of NCO in the isocyanate (A) to the polyol (P) is in the range of 1.0:2.5 to 2.5:1.0.
32. The polyurethane copolymer according to any of the embodiments 27 to 31, wherein the molar ratio of NCO in the isocyanate (A) to the polyol (P) is in the range of 1.0:2.0 to 2.0:1.0.
33. A process for preparing a polyurethane copolymer according to any of the embodiments 27 to 32 comprising at least the steps of:
i. providing at least one isocyanate (A), according to any of the embodiments 28 to 29;
ii. providing at least one polyol (P) according to any of the embodiments 1 to 20; and
iii. reacting (A) and (P).
34. The process according to embodiment 33, wherein the molar ratio of NCO in the isocyanate (A) to the polyol (P) is in the range of 1.0:10 to 10:1.0.
35. The process according to embodiment 34, wherein the molar ratio of NCO in the isocyanate(A) to the polyol (P) is in the range of 1.0:5 to 5:1.0.
36. The process according to embodiment 35, wherein the molar ratio of NCO in the isocyanate (A) to the polyol (P) is in the range of 1.0:3.0 to 1.0:1.5.
37. The process according to any of the embodiments 33 to 36, wherein step iii) carried out at a temperature in the range of −50° C. to 250° C.
38. A polyol (P) obtained by a process comprising the steps of:
i. providing at least one or at least two polyhydric alcohol;
ii. heating the polyhydric alcohol to a temperature in the range of 50 to 300° C.;
iii. providing a feed comprising ethylene oxide to the heated polyhydric alcohol of step ii.; and
iv. obtaining the polyalkyleneoxy polyol product,

wherein the polyol (P) having an average nominal functionality in the range of 2 to 8; a hydroxy number in the range of 10 to 500 mg KOH/g measured according to ASTM method D4272; a weight average molecular weight in the range of 500 to 25000 measured using GPC with polystyrene standard and tetrahydrofuran as solvent; wherein the polyol (P) comprises ethyleneoxy in an amount in the range of 50 to 95 wt. % based on overall weight of the polyol (P).
39. The polyol (P) obtained according to embodiment 38, wherein the at least one or at least two polyhydric alcohol is present in an amount in the range of 1 to 10 wt. % based on overall weight of the polyol (P).
40. The polyol (P) obtained according to embodiment 39, wherein the at least one or at least two polyhydric alcohol is present in an amount in the range of 1 to 5.0 wt. % based on overall weight of the polyol (P).
41. The polyol (P) obtained according to any one of the embodiments 37 to 40, wherein the polyol has an average nominal functionality in the range of >3 to <6.
42. The polyol (P) obtained according to embodiment 41, wherein the polyol has an average nominal functionality in the range of ≥3.1 to ≤5.
42. The polyol (P) obtained according to any one of the embodiments 37 to 41, wherein the polyol (P) has a hydroxy number in the range of 43 to 300 mg KOH/g measured according to ASTM method D4272.
43. The polyol (P) obtained according to embodiment 42, wherein the polyol has a hydroxy number in the range of 43 to 100 mg KOH/g measured according to ASTM method D4272.
44. The polyol (P) obtained according to any one of the embodiments 37 to 43, wherein the polyol has a weight average molecular weight in the range of 1000 to 10000 measured using GPC with polystyrene standard and tetrahydrofuran as solvent.
45. The polyol (P) obtained according to any one of the embodiments 37 to 44, wherein the polyol has a weight average molecular weight in the range of 2000 to 6000 measured using GPC with polystyrene standard and tetrahydrofuran as solvent.
46. The polyol (P) obtained according to embodiment 45, wherein the polyol has a weight average molecular weight in the range of 3000 to 6000 measured using GPC with polystyrene standard and tetrahydrofuran as solvent.
47. The polyol (P) obtained according to any one of the embodiments 37 to 46, wherein the ethyleneoxy is present in an amount in the range of 60 to 90 wt. % based on overall weight of the polyol.
48. The polyol (P) obtained according to embodiment 47, wherein the ethyleneoxy is present in an amount in the range of 65 to 90 wt. % based on the overall weight of the polyol.
49. The polyol (P) obtained according to embodiment 48, wherein the ethyleneoxy is present in an amount in the range of 65 to 80 wt. % based on the overall weight of the polyol.
50. The polyol (P) obtained according to embodiments 49, wherein the polyol has ethyleneoxy is present in an amount in the range of 70 to 80 wt. % based on the overall weight of the polyol.
51. The polyol (P) obtained according to any one of the embodiments 37 to 50, further comprises at least one oxyalkylene moieties selected from propyleneoxy, or butyleneoxy.
52. The polyol (P) obtained according to embodiment 51, wherein the at least one oxyalkylene moiety is propyleneoxy.
53. The polyol (P) obtained according to any one of the embodiments 37 to 52, wherein the oxyalkylene moiety according to any one of the embodiments 51 to 52 is present in an amount in the range of 1 to 40 wt. % based on overall weight of the polyol.
54. The polyol (P) obtained according to embodiment 53, wherein the oxyalkylene moiety is propyleneoxy present in an amount in the range of 1 to 40 wt. % based on overall weight of the polyol.
55. The polyol (P) obtained according to embodiment 54, wherein the propyleneoxy is present in an amount in the range of 5 to 30 wt. % based on the overall weight of the polyol.
56. The polyol (P) obtained according to embodiment 55, wherein the propyleneoxy is present in an amount in the range of 10 to 30 wt. % based on the overall weight of the polyol.
57. The polyol (P) obtained according to any one of the embodiments 37 to 56, wherein the polyol has viscosity in the range of 850 to 2000 cP at 25° C. measured using an LV-3 spindle.
58. A polyurethane copolymer obtained by reacting a reaction mixture comprising:
i. at least one isocyanate (A); and
ii. at least one polyol (P) according any one of the embodiments 37 to 57.
59. The polyurethane according to embodiment 58, wherein at least one isocyanate (A) is selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyhtris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate or polymeric forms of diisocyanates and triisocyanates.
60. The polyurethane copolymer according to any of the embodiments 58 to 59, wherein the at least one isocyanate is present in the form of a dimer, a trimer or an oligomer containing a urethane group, an isocyanurate group, a biuret group, an uretdione group, an allophanate group and/or an iminooxadiazinedione group.
61. The polyurethane copolymer according to any of the embodiments 58 to 60, wherein the molar ratio of NCO in the isocyanate (A) to the polyol (P) is in the range of 1.0:10 to 10:1.0.
62. The polyurethane copolymer according to any of the embodiments 58 to 61, wherein the molar ratio of NCO in the isocyanate (A) to the polyol (P) is in the range of 1.0:2.5 to 2.5:1.0.
63. The polyurethane copolymer according to any of the embodiments 58 to 62, wherein the molar ratio of NCO in the isocyanate (A) to the polyol (P) is in the range of 1.0:2.0 to 2.0:1.0.
64. An article comprising a polyurethane copolymer according to any of the embodiments 27 to 32 or according to any of the embodiments 58 to 63.

While the presently claimed invention has been described in terms of its specific embodiments, certain modifications and equivalents will be apparent to those skilled in the art and are intended to be included within the scope of the presently claimed invention.

Experimets

Method:

Gel viscosity: The gel viscosity was measured using Brookfield DV-Ill Ultra Programmable Rheometer using an LV-3 spindle. The rheometer was set to zero initially. At 25° C. 100 parts of polyol, 0.2 parts catalyst, and stoichiometric equivalent of isocyanate were mixed for one minute. Then the viscosity was measured over a period of 10 minutes at different intervals.
Glycerine is available from Proctor & Gamble USP Kosher.
Sorbitol is available from Archer Daniels Midland.
Ethylene oxide is available from BASF SE.
Propylene oxide is available from Dow.
KOH is available from J. T Baker as 45% aqueous solution.
Polyol A is available from BASF SE under the trade name P593.
Polyol B is available from BASF SE under the trade name P380.
Polyol D is available from BASF SE under the trade name P5132.
Polyol E is available from BASF SE under the trade name P1070
Polyol F is available from BASF SE under the trade name P1538
Polyol G is available from BASF SE under the trade name P4156
Surfactant A is available from Momentive under the trade name Niax L635.
Surfactant B is available from Momentive under the trade name Niax L627.
Surfactant C is is available from Evonik under the trade name DABCO DC-198.
Catalyst A is a solution of 33% by weight triethylenediamine and 67% by weight dipropylene glycol.
Catalyst B is a solution of 70% by weight bis-(2-dimethylaminoethyl)ether and 30% by weight dipropylene glycol.
Catalyst C is stannous octoate.
DEOA is diethanolamine.
TDI is available from BASF SE under the trade name T-80.
MDI is a MDI blend is available from BASF SE under the trade name L5100.
Blowing agent is methyl formate.

### Example 1 (Polyol P)

General Procedure for the preparation of polyol (P): glycerin (259.5 g), sorbitol (113 g) and potassium hydroxide (21.4 g) were charged to a reactor purged with nitrogen. The reactor was heated to 105° C. and stripped under vacuum for a period of 2 hours. The reactor was further charged with a mixture of ethylene oxide (10950 g) and propylene oxide (3738 g) over a period of 20 hours at 110° C. The mixture was then reacted for a period of 2 hours at 110° C. under 90 psi to obtain the polyol (P) in 15000 g. OH number is 46 mg KOH/g, average nominal functionality is 3.5, % EO in polyol 73 wt. % based on overall weight of the polyol. M. Wt. 4268 g/mol, primary hydroxy content 42.2% (primary hydroxy content from EO is 40.2% and primary hydroxy content from PO is 2%).

### Example 2

General procedure for the preparation of polyurethane foam: Hyper soft polyurethane foam was prepared in accordance with the existing technology.

The foams were made using a Cannon-Viking Slab Foam Machine. Each of the components in the formulation table was metered into a mixing head chamber via pumps where they were then mixed through high shear force. The reaction mixture in liquid form was then poured onto a moving conveyer where the reaction takes place. As the reaction occurs, foam buns are made measuring 42″ in height by 50″ in width by up 60 feet in length. The foam buns are allowed to cool and then cut. The cut sections are then sent to testing.

Gel viscosity of Polyurethane formation: This was performed on the benchtop, laboratory scale. At 25 Celsius,100 parts by weight of either Polyol A or Polyol P were added with 0.2 parts by weight of Catalyst C and the stoichiometric equivalent of TDI into a mixing cup. The resulting mixture was blended together for 1 minute using a mixing blade. The gel viscosity measured in accordance with the method disclosed above.

TABLE 1
Gel viscosity of Polyurethane formation.

Polyol

| | | |
|---|---|---|
| Time Interval, | Polyol A (comparative) | Polyol (P) |

| | |
|---|---|
| sec. | Viscosity |

| | | |
|---|---|---|
| 5 | 936 | 1146 |
| 10 | 948 | 1182 |
| 15 | 978 | 1188 |
| 20 | 990 | 1200 |
| 25 | 1014 | 1242 |
| 30 | 1020 | 1272 |
| 35 | 1038 | 1302 |
| 40 | 1050 | 1344 |
| 45 | 1062 | 1368 |
| 50 | 1092 | 1404 |
| 55 | 1116 | 1428 |
| 60 | 1140 | 1494 |
| 65 | 1176 | 1644 |
| 70 | 1200 | 1662 |
| 75 | 1230 | 1698 |
| 80 | 1260 | 1746 |
| 85 | 1290 | 1794 |
| 90 | 1320 | 1836 |
| 95 | 1356 | 1884 |
| 100 | 1392 | 1938 |
| 105 | 1422 | 1992 |
| 110 | 1458 | 2040 |
| 115 | 1500 | 2100 |
| 120 | 1536 | 2166 |
| 125 | 1578 | 2232 |
| 130 | 1620 | 2298 |
| 135 | 1662 | 2387 |
| 140 | 1710 | 2429 |
| 145 | 1758 | 2501 |
| 150 | 1800 | 2585 |
| 155 | 1854 | 2669 |
| 160 | 1908 | 2753 |
| 165 | 1956 | 2843 |
| 170 | 2016 | 2939 |
| 175 | 2076 | 3035 |
| 180 | 2130 | 3125 |
| 185 | 2190 | 3233 |
| 190 | 2262 | 3341 |
| 195 | 2322 | 3455 |
| 200 | 2393 | 3587 |
| 205 | 2471 | 3707 |
| 210 | 2543 | 3833 |
| 215 | 2615 | 3977 |
| 220 | 2705 | 4115 |
| 225 | 2789 | 4265 |
| 230 | 2873 | 4427 |
| 235 | 2975 | 4752 |
| 240 | 3065 | 4779 |
| 245 | 3155 | 4952 |
| 250 | 3269 | 5234 |
| 255 | 3383 | 5354 |
| 260 | 3491 | 5571 |
| 265 | 3611 | 5896 |
| 270 | 3743 | 6042 |
| 275 | 3863 | 6282 |
| 280 | 4001 | 6546 |
| 285 | 4145 | 6809 |
| 290 | 4295 | 7118 |
| 295 | 4439 | 7438 |
| 300 | 4706 | 7882 |
| 305 | 4766 | 8134 |
| 310 | 4939 | 8518 |
| 315 | 5256 | 8914 |
| 320 | 5316 | 9538 |
| 325 | 5511 | 9793 |
| 330 | 5956 | 10288 |
| 335 | 5947 | 10828 |
| 340 | 6170 | 11493 |
| 345 | 6410 | 12157 |
| 350 | 6749 | 12577 |
| 355 | 6919 | 13217 |
| 360 | 7198 | 13937 |
| 365 | 7498 | 14757 |
| 370 | 7894 | 15777 |
| 375 | 8098 | 16796 |
| 380 | 8446 | 17546 |
| 385 | 8806 | 18626 |
| 390 | 9367 | 19826 |
| 395 | 9928 | 21086 |
| 400 | 10018 | 22555 |
| 405 | 10423 | 24595 |
| 410 | 10873 | 26634 |
| 415 | 11495 | 27894 |
| 420 | 12117 | 29814 |
| 425 | 12417 | 32093 |
| 430 | 12977 | 34733 |
| 435 | 13497 | 37552 |
| 440 | 14197 | 40671 |
| 445 | 14817 | 44211 |
| 450 | 15717 | |
| 455 | 16616 | |
| 460 | 17126 | |
| 465 | 17996 | |
| 470 | 18896 | |
| 475 | 19856 | |
| 480 | 20816 | |
| 485 | 21955 | |
| 490 | 23447 | |
| 495 | 24939 | |
| 500 | 25914 | |
| 505 | 27174 | |
| 510 | 28674 | |
| 515 | 30294 | |
| 520 | 31973 | |
| 525 | 33773 | |
| 530 | 35752 | |
| 535 | 37792 | |
| 540 | 40131 | |
| 545 | 42591 | |

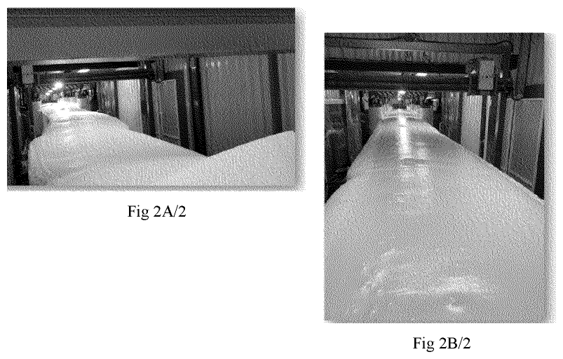

It is evident from table 1 that the polyurethane prepared using inventive polyol (P) of the presently claimed invention displayed remarkably fast curing compared to the comparative polyol A. This led to easy handling of the foam formed. This can be elucidated from FIGS. 2A and 2B that the PU foam formed in the production line display remarkably higher green strength compared to the comparative polyurethane.

TABLE 2

| | 1 | 2 | 3 | C1 | C2 | C3 |
|---|---|---|---|---|---|---|
| Formulation, | | | | | | |
| pbw | | | | | | |
| Polyol A | | | | 78.0 | 78.0 | 78.0 |
| Polyol B | 22.0 | 22.0 | 22.0 | 22.0 | 22.0 | 22.0 |
| Polyol (P) | 78.0 | 78.0 | 78.0 | | | |
| Water | 4.50 | 4.50 | 4.50 | 4.50 | 4.50 | 4.50 |
| Surfactant A | 1.40 | 1.40 | 1.40 | 1.40 | 1.40 | 1.40 |
| Catalyst A | 0.09 | 0.09 | 0.09 | 0.09 | 0.09 | 0.09 |
| Catalyst B | 0.03 | 0.03 | 0.03 | 0.03 | 0.03 | 0.03 |
| Catalyst C | 0.16 | 0.12 | 0.08 | 0.16 | 0.12 | 0.08 |
| Blowing Agent | 3.00 | 3.00 | 3.00 | 3.00 | 3.00 | 3.00 |
| TDI | 50.84 | 50.84 | 50.84 | 50.97 | 50.97 | 50.97 |
| Total PBW | 160.1 | 160.0 | 160.0 | 160.2 | 160.1 | 160.1 |
| Physical | | | | | | |
| Properties | | | | | | |
| Density, pcf | 0.99 | 1.01 | 1.02 | 1.06 | 1.09 | 1.08 |
| Tensile, psi | 10.4 | 13.2 | 13.9 | 8.2 | 9.8 | 11.4 |
| Elongation, % | 289 | 332 | 347 | 338 | 310 | 419 |
| HTAG | 9.9 | 11.4 | 11.6 | 7.1 | 8.5 | 9.6 |
| Tensile, psi | | | | | | |
| HTAG | 296 | 311 | 340 | 304 | 297 | 384 |
| Elongation, % | | | | | | |
| Tear, pi | 2.7 | 3.1 | 3.2 | 2.7 | 2.5 | 2.7 |
| Resilience, % | 43 | 43 | 44 | 40 | 44 | 47 |
| IFD, lb./50 sq. | | | | | | |
| in. (4 in.) | | | | | | |
| 25% | 9.3 | 10.0 | 10.0 | 9.9 | 9.9 | 9.2 |
| 65% | 19.9 | 21.7 | 22.0 | 21.2 | 21.3 | 20.4 |
| 25% Return | 6.0 | 6.7 | 6.8 | 6.7 | 6.8 | 6.6 |
| Support Factor | 2.15 | 2.17 | 2.20 | 2.13 | 2.16 | 2.20 |
| Recovery, % | 65 | 67 | 68 | 68 | 69 | 71 |
| Compression | | | | | | |
| Sets, % set | | | | | | |
| 50% | 10 | 8 | 13 | 8 | 8 | 7 |
| 90% | 16 | 22 | 39 | 8 | 10 | 12 |
| 50%** | 26 | 26 | 25 | 25 | 24 | 25 |
| 90%** | 43 | 40 | 41 | 41 | 57 | 44 |
| CFD, % Of | 54 | 48 | 47 | 44 | 45 | 41 |
| Original 50% | | | | | | |
| **Heat Aged | | | | | | |
| 22 hrs. @ | | | | | | |
| 284 F. | | | | | | |
| Air Flow, cfm | >8 | >8 | >8 | >8 | >8 | >8 |
| Fatigue | | | | | | |
| Properties | | | | | | |
| Static Fatigue | | | | | | |
| Height, % Loss | 3.8 | 4.0 | 4.7 | 2.7 | 3.4 | 4.4 |
| IFD, 25% Loss | 39.4 | 37.6 | 35.1 | 35.1 | 36.3 | 37.2 |
| IFD, 65% Loss | 34.0 | 32.7 | 30.7 | 31.7 | 31.4 | 32.1 |
| Pounding, | | | | | | |
| 80k cycles | | | | | | |
| Height, % Loss | 4.0 | 4.0 | 4.5 | 2.7 | 3.5 | 3.8 |
| 40% IFD, % | 44.1 | 42.6 | 39.0 | 41.5 | 40.9 | 38.9 |
| Loss | | | | | | |

TABLE 3

| | 4 | 5 | 6 | C4 | C5 | C6 |
|---|---|---|---|---|---|---|
| Formulation, | | | | | | |
| pbw | | | | | | |
| Polyol A | | | | 78.0 | 78.0 | 78.0 |
| Polyol B | 22.0 | 22.0 | 22.0 | 22.0 | 22.0 | 22.0 |
| Polyol (P) | 78.0 | 78.0 | 78.0 | | | |
| Water | 3.20 | 3.20 | 3.20 | 3.20 | 3.20 | 3.20 |
| Surfactant A | 1.40 | 1.40 | 1.40 | 1.40 | 1.40 | 1.40 |
| Catalyst A | 0.12 | 0.12 | 0.12 | 0.12 | 0.12 | 0.12 |
| Catalyst B | 0.04 | 0.04 | 0.04 | 0.04 | 0.04 | 0.04 |
| Catalyst C | 0.16 | 0.12 | 0.08 | 0.16 | 0.12 | 0.08 |
| TDI | 37.66 | 37.66 | 37.66 | 37.78 | 37.78 | 37.78 |
| Total PBW | 142.6 | 142.6 | 142.5 | 142.7 | 142.7 | 142.7 |
| Physical | | | | | | |
| Properties | | | | | | |
| Density, pcf | 1.62 | 1.67 | 1.70 | 1.77 | 1.77 | 1.82 |
| Tensile, psi | 20.4 | 20.8 | 19.6 | 20.5 | 22.8 | 22.5 |
| Elongation, % | 383 | 382 | 382 | 483 | 439 | 419 |
| HTAG | 17.5 | 19.9 | 19.0 | 17.8 | 21.0 | 20.9 |
| Tensile, psi | | | | | | |
| HTAG | 364 | 391 | 385 | 470 | 442 | 407 |
| Elongation, % | | | | | | |
| Tear, pi | 3.8 | 4.2 | 4.1 | 4.3 | 4.2 | 4.2 |
| Resilience, % | 31 | 38 | 41 | 33 | 30 | 40 |
| IFD, lb./50 | | | | | | |
| sq. in. (4 in.) | | | | | | |
| 25% | 14.9 | 14.6 | 14.6 | 14.0 | 14.9 | 14.6 |
| 65% | 33.9 | 33.0 | 32.0 | 32.1 | 34.3 | 33.1 |
| 25% Return | 10.8 | 10.8 | 11.1 | 10.4 | 11.4 | 11.5 |
| Support Factor | 2.28 | 2.27 | 2.20 | 2.30 | 2.30 | 2.27 |
| Recovery, % | 73 | 74 | 76 | 74 | 77 | 79 |
| Compression | | | | | | |
| Sets, % set | | | | | | |
| 50% | 11 | 6 | 4 | 9 | 5 | 4 |
| 90% | 69 | 55 | 24 | 62 | 58 | 43 |
| 50%** | 23 | 27 | 28 | 26 | 28 | 34 |
| 90%** | 66 | 66 | 70 | 63 | 57 | 73 |
| ** Heat Aged | | | | | | |
| 22 hrs. @ | | | | | | |
| 284 F. | | | | | | |
| CFD, % Of | 37 | 37 | 33 | 33 | 33 | 31 |
| Original 50% | | | | | | |
| Air Flow, cfm | 1.76 | 2.15 | 2.58 | 1.27 | 0.95 | 1.83 |
| Fatigue | | | | | | |
| Properties | | | | | | |
| Static Fatigue | | | | | | |
| Height, % Loss | 5.2 | 2.9 | 3.0 | 3.5 | 2.9 | 4.3 |
| IFD, 25% Loss | 32.3 | 26.4 | 28.5 | 32.9 | 27.9 | 28.0 |
| IFD, 65% Loss | 27.6 | 23.2 | 26.3 | 28.9 | 25.6 | 24.9 |
| Pounding, | | | | | | |
| 80k cycles | | | | | | |
| Height, % Loss | 3.4 | 3.2 | 1.9 | 2.8 | 2.8 | 3.1 |
| 40% IFD, % | 34.7 | 36.6 | 30.3 | 35.4 | 30.8 | 31.7 |
| Loss | | | | | | |

It is evident from tables 2 and 3 that the polyurethane foam formed display similar properties even though inventive polyol according to presently claimed invention led to faster curing of the polyurethane foam.

The foams in table 4 were made on the benchtop, laboratory scale. All the components were measured out and poured into a mixing cup. The components in the mixing cup were then mixed via a mixing blade and subsequently poured into a 5-gallon pale liner. The reaction takes place in the 5-gallon pale liner. After the foam has cured, it is cut and sent to physical testing.

TABLE 4
Handmix Evaluation of inventive polyol in
a variety of Viscoelastic Formulations.

| | C7 | 7 | C8 | 8 | C9 | 9 |
|---|---|---|---|---|---|---|
| Formulations, pbw | | | | | | |
| Polyol (P) | | 57.0 | | 57.0 | | 35.0 |
| Polyol D | 40.0 | 40.0 | 40.0 | 40.0 | 20.0 | 20.0 |
| Glycerin | 3.0 | 3.0 | 3.0 | 3.0 | | |
| Polyol A | 57.0 | | 57.0 | | 35.0 | |
| Polyol B | | | | | 15.0 | 15.0 |
| Polyol E | | | | | 30.0 | 30.0 |
| Surfactant B | 2.00 | 2.00 | 2.00 | 2.00 | 1.00 | 1.00 |
| DEOA | 1.20 | 1.20 | 1.20 | 1.20 | | |
| Catalyst A | 0.12 | 0.12 | 0.12 | 0.12 | .22 | .22 |
| Catalyst B | 0.02 | 0.02 | 0.02 | 0.02 | .11 | .11 |
| Catalyst C | 0.10 | 0.10 | 0.10 | 0.10 | 0.04 | 0.04 |
| Water Total | 1.88 | 1.88 | 1.98 | 1.98 | 2.00 | 2.00 |
| Water added | 1.70 | 1.70 | 1.80 | 1.80 | 2.00 | 2.00 |
| TDI, pbw | 30.81 | 30.73 | 10.79 | 10.77 | 12.49 | 12.47 |
| MDI, pbw | 0.00 | 0.00 | 16.01 | 15.97 | 18.56 | 18.53 |
| Foam Properties | | | | | | |
| Density, pcf | 2.88 | 2.82 | 5.29 | 4.93 | 3.04 | 3.03 |
| Tear, pi | 1.8 | 1.8 | 1.2 | 1.3 | 1.0 | 1.0 |
| Falling ball resilience, % | 15 | 16 | 19 | 18 | 17 | 17 |
| IFD, Lbs (4 inch) | | | | | | |
| 25% Defl. | 11.3 | 13.0 | 32.5 | 31.9 | 7.1 | 9.2 |
| 65% Defl. | 24.9 | 27.6 | 75.0 | 73.4 | 14.8 | 19.1 |
| Sag Factor | 2.21 | 2.12 | 2.30 | 2.31 | 2.09 | 2.07 |
| Recovery, % | 8 | 8 | 1 | 1 | 12 | 7 |
| Comp. Sets, 50% | 33 | 35 | 4 | 3 | 32 | 23 |
| 90% | 81 | 84 | 25 | 5 | 82 | 80 |
| 50% humid aged | 38 | 37 | 5 | 4 | 43 | 38 |
| 90% humid aged | 75 | 79 | 77 | 72 | 81 | 83 |
| Recovery Time, seconds | 8 | 8 | 1 | 1 | 12 | 7 |
| Air flow, cfm | 0.3 | 0.3 | 0.1 | 0.1 | 0.3 | 0.3 |

The foams in table 5 were similar to the foams disclosed in table 4, however, the reaction mixture is poured into a pillow mold heated at 125 F. After 10 minutes, the pillows are taken out of the mold and allowed to cool. After cooling, the pillows are sent to testing.

TABLE 5
Molded Pillows formed using inventive polyol.

| | C10 | 10 | C11 | 11 |
|---|---|---|---|---|
| Formulations, pbw | | | | |
| Polyol A | 82 | | 82 | |
| Polyol (P) | | 82 | | 82 |
| Polyol F | | | 18 | 18 |
| Polyol G | 18 | 18 | | |
| Surfactant C | 1.5 | 1.5 | 1.5 | 1.5 |
| Catalyst A | 0.25 | 0.25 | 0.25 | 0.25 |
| Catalyst B | 0.25 | 0.25 | 0.25 | 0.25 |
| WATER | 3 | 3 | 3 | 3 |
| MDI | 43.9 | 43.9 | 43.9 | 43.9 |
| Foam Properties | | | | |
| Air Flow, cfm | >8 | >8 | >8 | >8 |
| CFD Humid Aged, 50% Loss | 36 | 36 | 36 | 34 |
| CFD Humid Aged, 50% Retained | 64 | 64 | 64 | 66 |
| Compression Set (Ct) 50% | 4 | 5 | 4 | 4 |
| Compression Set (Ct) 90% | 3 | 5 | 4 | 6 |
| Compression Set Humid | 7 | 7 | 5 | 5 |
| Aged(Ct) 50% | | | | |
| Compression Set Humid | 7 | 7 | 4 | 5 |
| Aged(Ct) 90% | | | | |
| Core Density, pcf | 2.63 | 2.73 | 2.71 | 2.79 |
| Original IFD at 25% | 5.8 | 7.5 | 7.0 | 9.2 |
| Original IFD at 65% | 15.6 | 20.0 | 17.3 | 22.5 |
| Original IFD at 25% Return | 5.3 | 6.8 | 6.6 | 8.3 |
| % Recovery | 92 | 91 | 94 | 90 |
| Support Factor | 2.69 | 2.67 | 2.48 | 2.46 |
| Recovery Time, sec | 1 | 1 | 1 | 1 |
| D3574 Resilience, % | 27 | 30 | 25 | 25 |
| Tensile Strength, psi | 8.2 | 8.7 | 7.0 | 7.1 |
| Ultimate Elongation, % | 173 | 149 | 153 | 130 |
| Tg, degree celsius | 0 | −5 | −1 | −1 |

It is evident for tables 5 that the polyurethane foam formed with inventive polyol provided excellent load bearing capacity (IFD at 25% loss and 65% loss) without compromising the other physical parameters in the molded applications.

1-65. (canceled)

66: A polyalkyleneoxy polyol (P), having an average nominal functionality in the range of 2 to 8;
a hydroxy number in the range of 10 to 500 mg KOH/g measured according to ASTM method D4272;
a weight average molecular weight in the range of 500 to 25,000 measured using GPC with polystyrene standard and tetrahydrofuran as solvent;
wherein the polyol comprises ethyleneoxy in an amount in the range of 50 to 95 wt. % based on an overall weight of the polyol (P), and a primary hydroxy content is in the range of 30 to 65% based on a total hydroxy content of the polyol (P).

67: The polyol (P) according to claim 66, further comprising at least one oxyalkylene moiety selected from the group consisting of propyleneoxy and butyleneoxy.

68: The polyol (P) according to claim 66, wherein the polyol (P) has a viscosity in the range of 850 to 2,000 cP at 25° C. measured using an LV-3 spindle.

69: A process for preparing the polyalkyleneoxy polyol (P) according to claim 66, the process comprising:
i) providing at least one or at least two polyhydric alcohol;
ii) heating the at least one or at least two polyhydric alcohol to a temperature in the range of 50 to 300° C.;
iii) providing a feed comprising ethylene oxide to the heated polyhydric alcohol of ii); and
iv) obtaining a polyalkyleneoxy polyol product.

70: The process according to claim 69, wherein the feed provided in iii) further comprises at least one oxyalkylene moiety selected from the group consisting of propyleneoxy and butyleneoxy, which is present in amount in the range of 1 to 40 wt. % based on a total weight of the feed.

71: A polyurethane copolymer, obtained by reacting a reaction mixture comprising:
i. at least one isocyanate (A); and
ii. at least one polyol (P) according to claim 66.

72: The polyurethane according to claim 71, wherein the at least one isocyanate (A) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)₃NCO, OCN(CH₂)₃N(CH₃)CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate, and polymeric forms of diisocyanates and triisocyanates.

73: The polyurethane copolymer according to claim 71, wherein the molar ratio of NCO in the at least one isocyanate (A) to the at least one polyol (P) is in the range of ≥1.0:10 to ≤10:1.0.

74: A process for preparing a polyurethane copolymer according to claim 71, the process comprising at least:
i) providing the at least one isocyanate (A):
ii) providing the at least one polyol (P); and
iii) reacting (A) and (P).

75: The process according to claim 74, wherein the molar ratio of NCO in the at least one isocyanate (A) to the at least one polyol (P) is in the range of ≥1.0:10 to ≤10:1.0.

76: The process according to claim 74, wherein iii) is carried out at a temperature in the range of ≥−50° C. to ≤250° C.

77: A polyol (P), obtained by a process comprising:
i) providing at least one or at least two polyhydric alcohol;
ii) heating the at least one or at least two polyhydric alcohol to a temperature in the range of 50 to 300° C.;
iii) providing a feed comprising ethylene oxide to the heated polyhydric alcohol of ii); and
iv) obtaining a polyalkyleneoxy polyol product,
wherein the polyol (P) has an average nominal functionality in the range of 2 to 8; a hydroxy number in the range of 10 to 500 mg KOH/g measured according to ASTM method D4272: a weight average molecular weight in the range of 500 to 25,000 measured using GPC with polystyrene standard and tetrahydrofuran as solvent; and
wherein the polyol (P) comprises ethyleneoxy in an amount in the range of 50 to 95 wt. %, based on an overall weight of the polyol (P).

78: The polyol (P) according to claim 77, wherein the polyol (P) has an average nominal functionality in the range of >3 to <6.

79: The polyol (P) according to claim 77, further comprising at least one oxyalkylene moiety selected from the group consisting of propyleneoxy and butyleneoxy.

80: The polyol (P) according to claim 79, wherein the at least one oxyalkylene moiety is propyleneoxy.

81: The polyol (P) according to claim 77, wherein the polyol (P) has a viscosity in the range of 850 to 2.000 cP at 25° C. measured using an LV-3 spindle.

82: A polyurethane copolymer, obtained by reacting a reaction mixture comprising:
i) at least one isocyanate (A); and
ii) at least one polyol (P) according to claim 77.

83: The polyurethane according to claim 82, wherein at least one isocyanate (A) is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine, 3,3′-dimethyl-4,4′-diisocyano biphenyl, 3,3′-dimethoxy-biphenylene diisocyanate, 2, 4-bis(b-isocyanato-t-butyl)toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis (3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH₂)₃O(CH₂)₂O(CH₂)NCO, OCN(CH₂)₃N(CH₃)(CH₂)₃NCO, triphenylmethane-4,4′,4″-triisocyanate, toluene-2,4,6-triyl triisocyanate, ethyl ester 1-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2h,4h,6h)-triyl)tris(hexamethylene) isocyanate, 1,3,5-triisocyanatobenzene, tris(isocyanatohexyl)biuret, 3,3′,3″-[(1h,3h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate, and polymeric forms of diisocyanates and triisocyanates.

84: The polyurethane copolymer according to claim 82, wherein the molar ratio of NCO in the at least one isocyanate (A) to the at least one polyol (P) is in the range of ≥1.0:10 to ≤10:1.0.

85: An article, comprising the polyurethane copolymer according to claim 71.
